(19) United States
(12) Patent Application Publication
(10) Pub. No.: US 2024/0410209 A1
(43) Pub. Date: Dec. 12, 2024

(54) GATE SUPPORT SYSTEM

(71) Applicant: JOHN B CARBER, Sr., HELLERTON, PA (US)

(72) Inventor: JOHN B CARBER, Sr., HELLERTON, PA (US)

(21) Appl. No.: 18/435,037

(22) Filed: Feb. 7, 2024

Related U.S. Application Data
(60) Provisional application No. 63/471,998, filed on Jun. 9, 2023.

(51) Int. Cl. E05C 17/44

(52) U.S. Cl. CPC E05C 17/446

(57) ABSTRACT

The present invention is directed to a device for supporting an unmounted end of a gate, barrier, or fence, the device including: a support shaft, including: a handle portion; a pin or extrusion extending from the support shaft; and a foot; and an elevating bracket, including: a channel to receive the support shaft; one or more notches, configured to receive the pin or extrusion; and one or more attachment portions for attaching the device to the unmounted end of the gate, barrier or fence. A user supporting a gate by lowering the support shaft to the ground until the foot is in contact with the ground, and then rotating the support shaft such that the pin is held between two notches.

### RELATED APPLICATIONS

The present application depends on and claims priority to U.S. Provisional Patent Application Ser. No. 63/471,998, filed 9 Jun. 2023, entitled “Gate Support System,” which is incorporated herein by reference in its entirety.

### FIELD OF THE INVENTION

In general, the present invention is directed to systems of supporting and lifting movable gates. More specifically, at least some embodiments of the present invention provide for systems that provide adjustable support elements that may lift a distal end of a movable gate.

### BACKGROUND

Gates are used in a variety of settings to control entry and exit to various areas. For example, gates may be used to permit or prevent livestock entrance to various fields. Gates may be used to restrict access to construction sites, for example safety or security reasons. Gates may be used to prevent entrance to certain areas, for example swimming pools or other attractive nuisances.

In accordance with some embodiments, gates may be swinging or sliding. A sliding gate may be pivotally attached to a post (for example, through one or more hinges), and the gate may be cantilevered off of the post. This cantilever may cause a moment to be imparted on the post, which may cause undesirable effects. For example, over time the post may be gradually pulled out of a vertical or substantially vertical plumb position. Hinge attachments to the post may slip.

Over time, hinge pins may be bent out of shape. In addition, the gate structure itself may deteriorate, causing the gate to lose shape and slide out of “square.” In addition to structural issues, such effects may also cause misalignment with latching hardware, preventing the gate from being secured.

These undesirable effects may also impact a sliding gate. A sliding gate may be supported at a top and bottom portion, and may slide away from a post, into the area for which entrance/exit is to be controlled. Once slid open, a sliding gate may again cantilever off the post and again cause a moment to be applied to the post, with potential deleterious effects as noted above.

Support of a gate is complicated by inconsistent and irregular terrain over which the gate may be opened or closed. For example, in a pasture setting the distance from a bottom surface of a gate to the ground in an open position may be significantly different than the distance from the bottom surface of the gate to the ground in a closed position. Moreover, ground materials may vary from firm flat surfaces—such as asphalt or concrete, to soft or irregular surfaces—such as dirt, mud, grass, or other field conditions.

Accordingly, a gate support device that may be used to support a gate panel, prevent and/or counteract undesirable moments, and provide support in varying conditions is desirable.

### SUMMARY OF THE INVENTION

Some aspects in accordance with some embodiments of the present invention may include a device for supporting an unmounted end of a gate, barrier, or fence, the device comprising: a support shaft, comprising: a handle portion; a pin or extrusion extending from the support shaft; and a foot; and an elevating bracket, comprising: a channel to receive the support shaft; one or more notches, configured to receive the pin or extrusion; and one or more attachment portions for attaching the device to the unmounted end of the gate, barrier or fence.

Some aspects in accordance with some embodiments of the present invention may include a device for supporting an unmounted end of a gate, barrier, or fence, the device comprising: a support shaft, comprising: a handle portion, formed from a bent portion of the support shaft; a pin or extrusion extending substantially perpendicularly from an axis of the support shaft; and a foot, comprising: a shaft, the shaft having a slot therein; a contact plate mounted on or attached to the shaft, the contact plate providing a planar surface substantially perpendicular to an axis of the shaft; a spring; and a fastener; and an elevating bracket, comprising: a channel to receive the support shaft; one or more notches, extending substantially perpendicular to the axis of the support shaft and configured to receive the pin or extrusion; and one or more attachment portions for attaching the device to the unmounted end of the gate, barrier or fence.

These and other aspects will become apparent from the following description of the invention taken in conjunction with the following drawings, although variations and modifications may be effected without departing from the spirit and scope of the novel concepts of the invention.

### DESCRIPTION OF THE DRAWINGS

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary gate jack system in an engaged position, in accordance with some embodiments of the present invention.

FIG. 2 illustrates an exemplary gate jack system in an unengaged position, in accordance with some embodiments of the present invention.

FIG. 3A illustrates a front view of an exemplary latching system, in accordance with some embodiments of the present invention.

FIG. 3B illustrates a side view of an exemplary latching system, in accordance with some embodiments of the present invention.

FIG. 4 illustrates an exemplary foot, in accordance with some embodiments of the present invention.

FIG. 5 shows a photograph an exemplary gate jack system installed on a metal gate, in accordance with some embodiments of the present invention.

FIG. 6 shows a close-up photograph of an exemplary gate jack system installed on a metal gate, in accordance with some embodiments of the present invention.

FIG. 7 shows a photograph of an exemplary gate jack system installed on a wooden gate, in accordance with some embodiments of the present invention.

FIG. 8 shows a close-up photograph of an exemplary gate jack system installed on a wooden gate, in accordance with some embodiments of the present invention.

FIG. 9 shows a photograph of an exemplary foot for use with a gate jack system, in accordance with some embodiments of the present invention.

### DETAILED DESCRIPTION

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

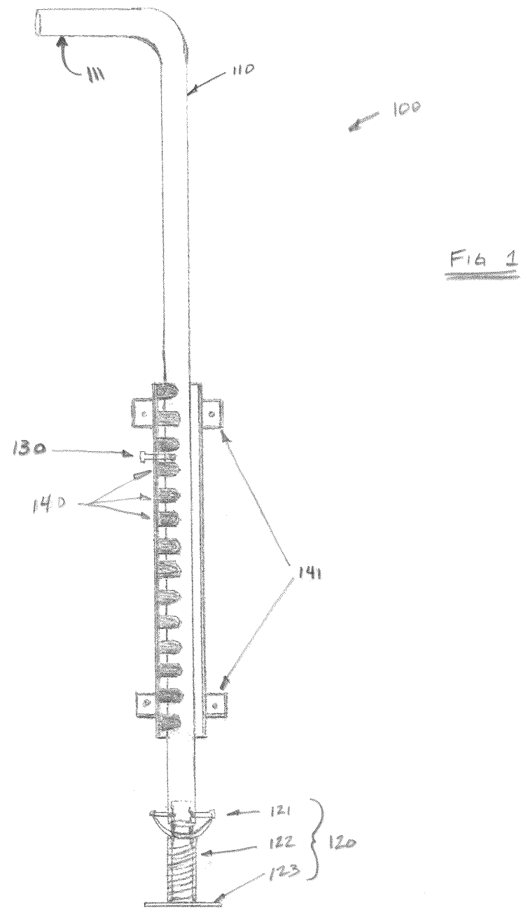

In general, the present invention is directed to systems of supporting and lifting movable gates. More specifically, at least some embodiments of the present invention provide for systems that provide adjustable support elements that may lift a distal end of a movable gate. With reference to FIG. 1, an exemplary gate jack system 100, in accordance with some embodiments of the present invention will now be discussed. System 100 may comprise a support shaft 110, which may be in the shape of a cane bolt with a handle portion 111. A lower portion of the support bolt 110 may be attached or connected to foot 120. Foot 120 may comprise fastener 121, spring 122, and foot portion 123. The spring 122 may be compressed between fastener 121 and foot portion 123, to provide a force exerted back upwards towards the support bolt 110, and accordingly, a gate attached to the system 100.

System 100 may further comprise a pin 130 attached to the support shaft 110. Pin 130 may comprise a bolt, protrusion, etc. that may extend from the support shaft 110. As shown in FIG. 1, pin 130 may extend in a perpendicular or substantially perpendicular direction from the support shaft 110.

System 100 may further comprise elevating bracket 140, which comprises a series of notches, into which pin 130 may be inserted. Elevating bracket 140 may be mounted to a gate via attachments 140, which may vary slightly if the system 100 is to be mounted to a wooden gate, metal gate, vinyl gate, etc.

In operation the support shaft 110 may be rotated such that the pin 130 is not engaged in any notch in the elevating bracket 140. Support shaft 110 may then be raised or lowered. Once the support shaft 110 is in a desired position, the support shaft 110 may be rotated, engaging pin 130 into an appropriate notch in the elevating bracket 140. If the support shaft 110 is lowered to contact the ground, foot 120 may rest on the ground, and an upward force may be provided by spring 122. FIG. 1 illustrates an exemplary gate jack 100 in an engaged position.

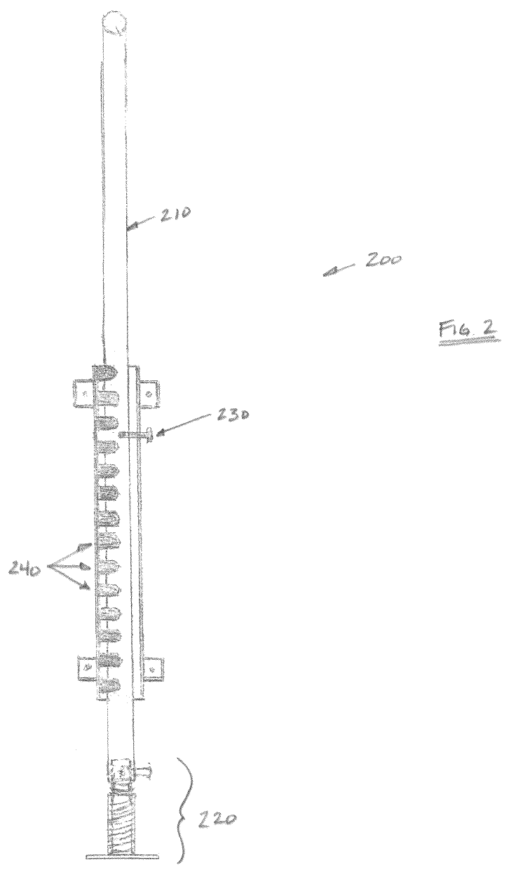

With reference to FIG. 2, an exemplary gate jack system 200 is shown in an unengaged position, in accordance with some embodiments of the present invention. FIG. 2 illustrates a support shaft 210, a foot 220 attached to a lower end of the support shaft 210, pin 230, and elevating bracket 240. In FIG. 2, it can be seen that the support shaft 210 has been rotated such that the pin 230 is not engaged in any notch in the elevating bracket 240. The support shaft 210 is then free to move up and down.

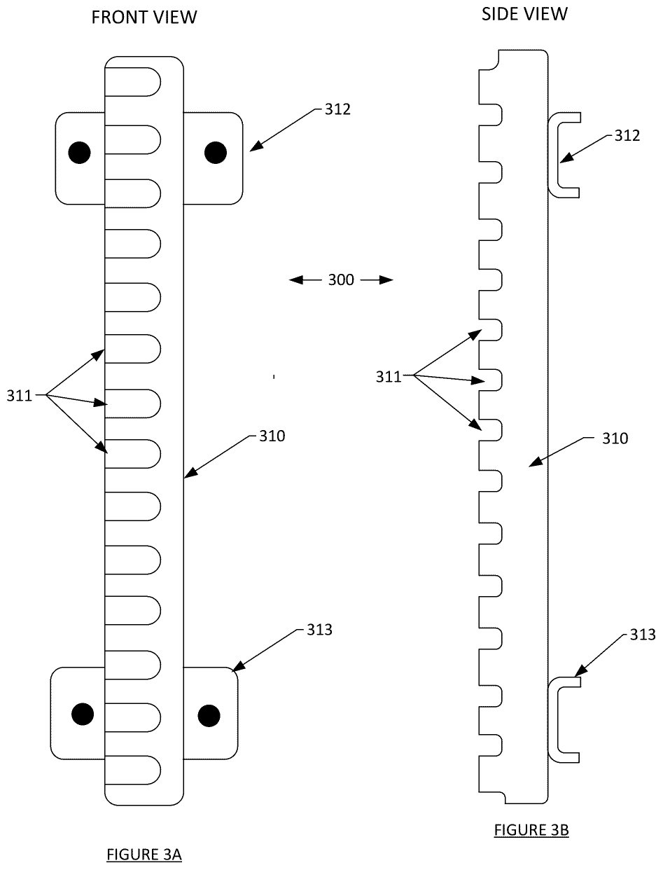

FIGS. 3A and 3B illustrate a front view and side view, respectively, of an elevating bracket 300, in accordance with some embodiments of the present invention. Elevating bracket 300 may comprise numerous notches 311, which may be configured to receive a pin or other element present on a support shaft. Elevating bracket 300 may also comprise attachment elements 312, 313, which may be used to attach the elevating bracket 300 to a fence. Attachment elements 312, 313 may vary depending on the type of gate to which the elevating bracket 300. For example, if the elevating bracket 300 is to be attached to a metal gate that is assembled from metal tubing, the attachment elements may be used with U-bolts or other fasteners in conjunction with a channel. If the elevating bracket 300 is to be attached to a wooden gate, wood screws or bolts may be utilized directly through the attachment elements 312, 313. If the elevating bracket 300 is to be attached to a vinyl gate, “L” shaped brackets may be used.

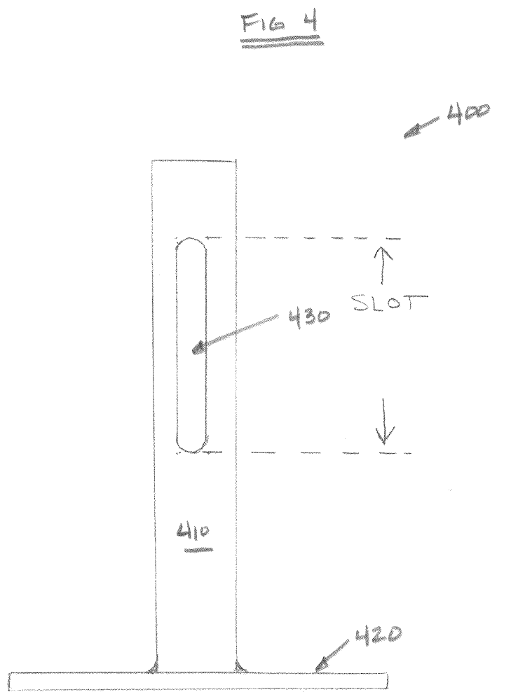

With reference to FIG. 4, an exemplary foot 400, in accordance with some embodiments of the present invention will now be discussed. Foot 400 may comprise a shaft 410, contact plate 420, and slot 430. Shaft 410 may mount the foot into or onto a support shaft of an overall gate jack system. Foot 420 may be configured to contact the ground, and may have a wide surface if the ground is or is anticipated to be soft (such as dirt or pasture), or comprise a smaller footprint if the ground is or is anticipated to be hard or firm (such as asphalt or concrete).

Slot 430 may be configured to receive a fastener which may be attached to a spring, as shown in FIGS. 1-2. Slot 430 may permit the foot 400 to vertically travel after being attached to a support shaft with a spring.

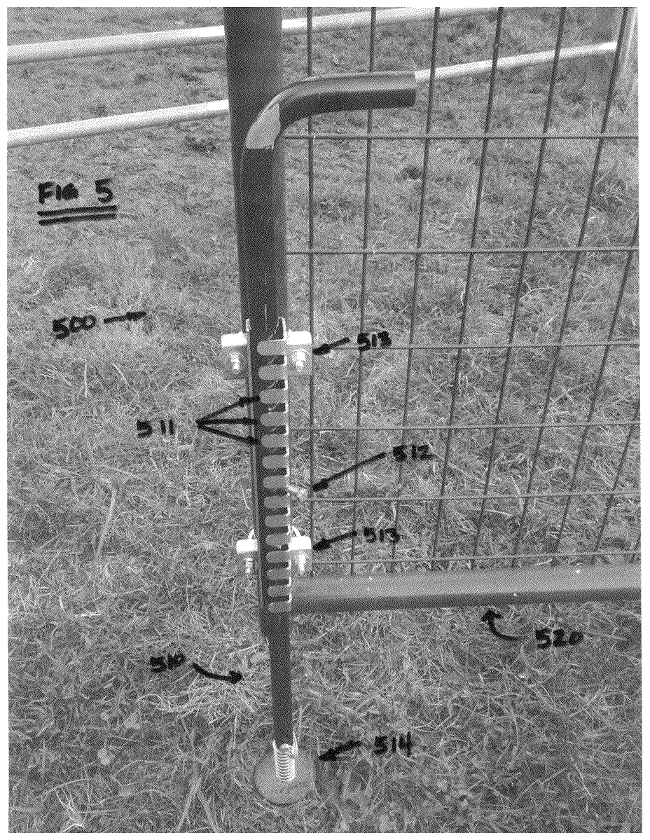

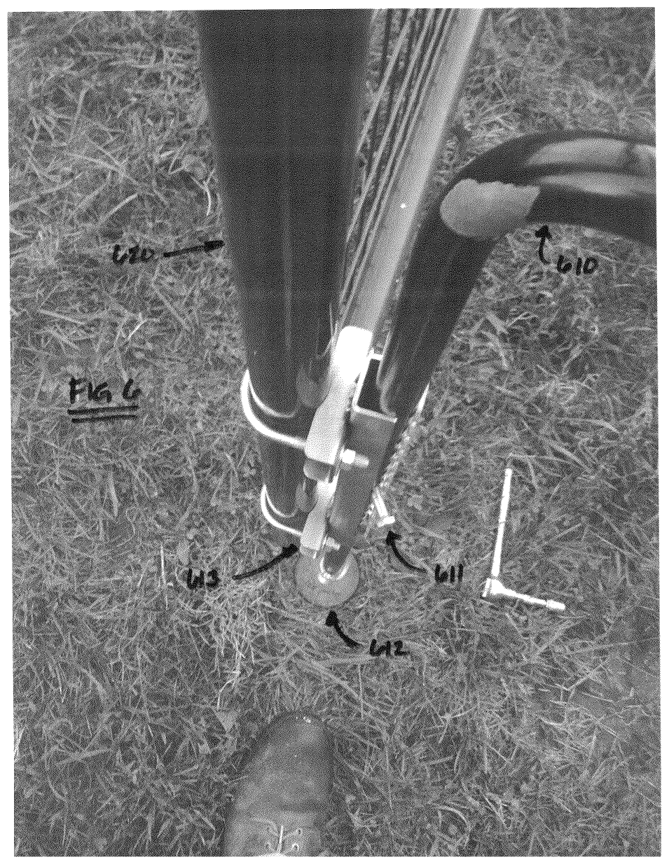

FIG. 5 illustrates a gate jack system 500, comprising a gate jack 510 mounted to a metal gate 520, in accordance with some embodiments of the present invention. Gate jack 510 may comprise a support shaft, an elevating bracket with notches 511, a support pin 512, one or more attachment device 513 for connecting the gate jack to a gate 520, and a foot 514 for contact with the ground. FIG. 6 shows a closer view of a gate jack attached to a metal gate 620, in accordance with some embodiments of the present invention. Gate jack may comprise a support shaft 610, support pin 611, foot 612, and one or more attachment elements 613.

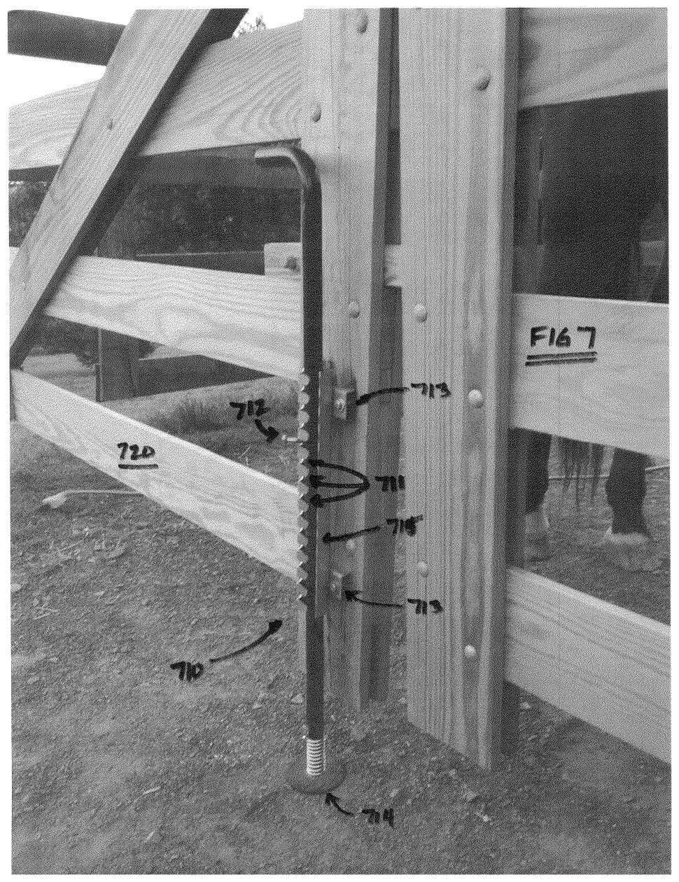

FIG. 7 illustrates a gate jack system 710 attached to a wooden gate 720, in accordance with some embodiments of the present invention. Gate jack system may comprise a support shaft, comprising an attached support pin 712, which may be pivoted into a notch on elevating bracket 711. Support shaft may also comprise a foot 714 for contact with the ground. The gate jack system may further comprise a channel715, which may at least partially wrap around support shaft, and which may be attached to a gate 720 via one or more attachment elements 713.

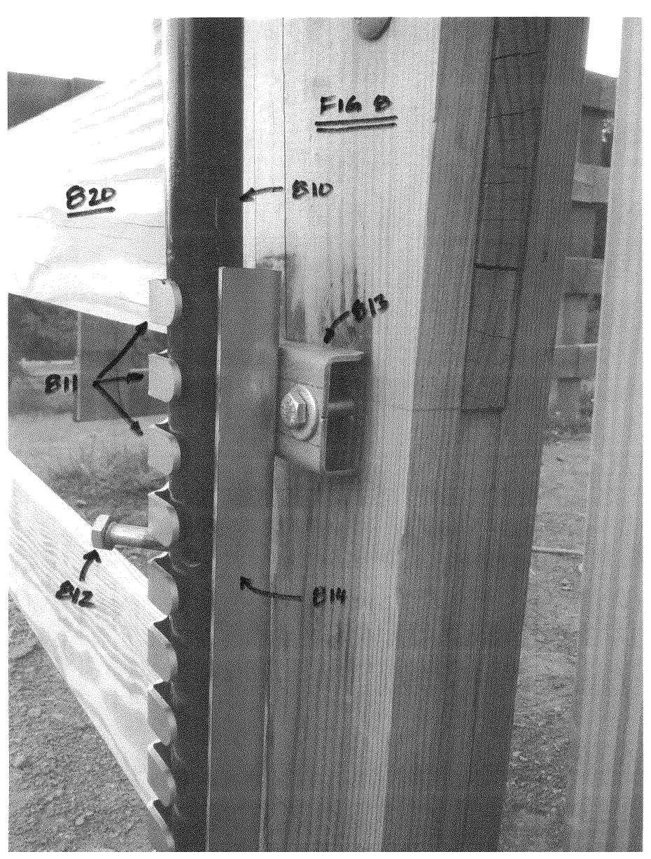

FIG. 8 depicts a close-up view of a gate jack system attached to a wooden gate 820, in accordance with some embodiments of the present invention. Gate jack system may comprise a support shaft 810, which may comprise a support pin 812. Support pin 812 may be inserted into a notch in elevating bracket 811. Gate jack system may be mounted to a wooden gate via attachment element(s) 813 (shown to be attached using a woodscrew, carriage bolt, nut-and-bolt, etc.). As noted above, channel 814 may wrap around support shaft 810, such that support shaft 810 is held in a vertical or substantially vertical position.

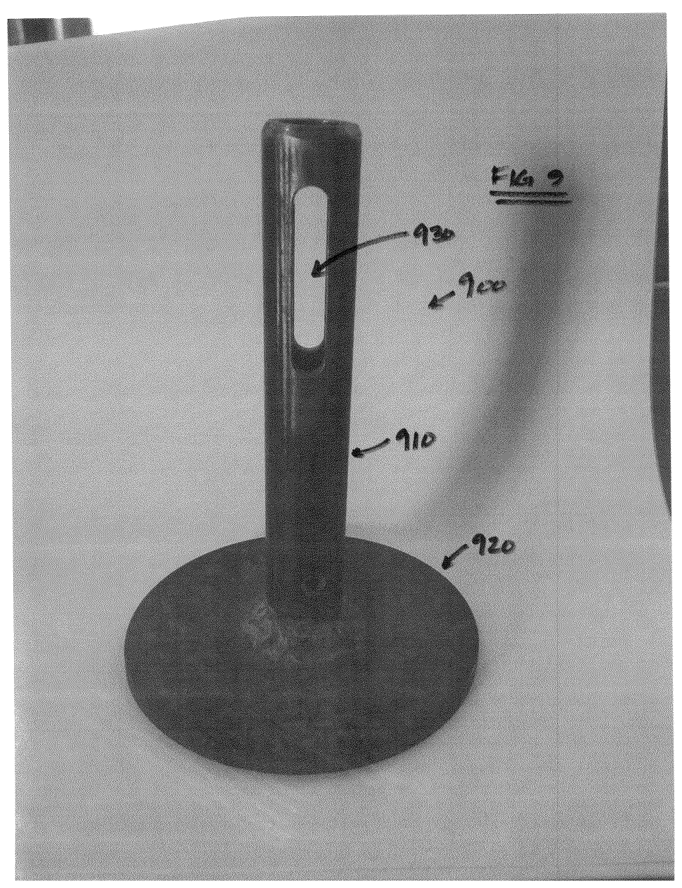

FIG. 9 illustrates an exemplary foot 900, in accordance with some embodiments of the present invention. Foot 900 may comprise a shaft 910, contact plate 920, and slot 930. Shaft 910 may mount the foot into or onto a support shaft of an overall gate jack system. Foot 920 may be configured to contact the ground and may have a wide surface if the ground is or is anticipated to be soft (such as dirt or pasture), or comprise a smaller footprint if the ground is or is anticipated to be hard or firm (such as asphalt or concrete).

As noted above, systems in accordance with some embodiments of the present invention may apply continuous upward support at or near a distal end of the gate, where it is furthest from a post to which the gate is mounted. In general, systems in accordance with some embodiments of the present invention may comprise three (3) main components: an elevating bracket, a support shaft or bolt, and a spring-loaded foot.

The elevating bracket may be designed to mount to a wood gate with through bolts and/or metal tube gate with wraparound clamps. Slots/notches may be present on one side of the bracket (left or right depending on positioning) to accommodate/receive the support bolt at various heights. This range may accommodate changes in terrain elevations as the gate travels its path when opening and closing. Notches accept support bolt and notch bolt. Next to the slots/notches may be a clear vertical travel channel where the support bolt can travel freely up and down to where its level will most effectively support the gate, at which point it can be turned into its appropriate slot/notch thereby engaging/delivering support. The support bolt (referenced below) when functioning with the elevating bracket can be elevated/raised to allow for unimpeded gate travel when opening or closing and then lowered at any point in its travel path to provide previously described support. The system may have the ability to adjust to varying terrain elevations and deliver support when gate reaches a desired position. The elevating bracket and cane may be made to function on both sides of a gate depending on how it is hung/swings. On a split gate, the unit may be hung on either gate, and either side and maintain full function.

The support bolt (overall unit to include cane and elevating bolt) may be drilled through the bottom to allow a pin to be inserted and hold the foot in place. Two additional holes may be drilled and tapped at, or about at ninety (90) degrees from each other for the elevating bolt. These two (2) tapped holes may allow the cane to rise up and down when the handle is perpendicular or substantially perpendicular to the gate and then fold in along the gate when being slotted and providing support. The hole positions may also allow the apparatus to be switched to work on both sides of the gate depending on how it hangs and again on all sides of a split gate.

The spring loaded foot may have a slotted post to allow the foot to be held in place in relation to the cane bolt, specific to rotation, while allowing for movement up and down to allow the compression spring to be “loaded” with supporting force through compression while also allowing the elevating bolt to find a useful, optimal slot for the cane bolt to be turned and locked into, at which point the compression spring may then apply its supporting upward force.

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense.

What is claimed is:

1. A device for supporting an unmounted end of a gate, barrier, or fence, the device comprising:
a support shaft, comprising:
a handle portion;
a pin or extrusion extending from the support shaft; and
a foot; and
an elevating bracket, comprising:
a channel to receive the support shaft;
one or more notches, configured to receive the pin or extrusion; and
one or more attachment portions for attaching the device to the unmounted end of the gate, barrier or fence.

2. The device of claim 1, wherein the handle portion comprises an angled portion of the support shaft.

3. The device of claim 1, wherein the pin or extrusion extends substantially perpendicularly from the support shaft.

4. The device of claim 1, wherein the foot comprises:
a shaft, the shaft having a slot therein;
a contact plate mounted on or attached to the shaft, the contact plate providing a planar surface substantially perpendicular to an axis of the shaft;
a spring; and
a fastener.

5. The device of claim 4, wherein the fastener extends through the slot and connects the shaft to the support shaft.

6. The device of claim 5, wherein the spring is disposed such that it exerts a force between the shaft and the support shaft.

7. The device of claim 1, wherein the channel to receive the support shaft has a substantially rectangular cross-section.

8. The device of claim 1, wherein the one or more notches in the elevating bracket extend substantially perpendicular to an axis of the support shaft.

9. A device for supporting an unmounted end of a gate, barrier, or fence, the device comprising:
a support shaft, comprising:
a handle portion, formed from a bent portion of the support shaft;
a pin or extrusion extending substantially perpendicularly from an axis of the support shaft; and
a foot, comprising:
a shaft, the shaft having a slot therein;
a contact plate mounted on or attached to the shaft, the contact plate providing a planar surface substantially perpendicular to an axis of the shaft;
a spring; and
a fastener; and
an elevating bracket, comprising:
a channel to receive the support shaft;
one or more notches, extending substantially perpendicular to the axis of the support shaft and configured to receive the pin or extrusion; and
one or more attachment portions for attaching the device to the unmounted end of the gate, barrier or fence.

10. The device of claim 9, wherein the support shaft rotates in the elevating bracket about the axis of the support shaft.

11. The device of claim 9, wherein the fastener extends through the slot and connects the shaft to the support shaft.

12. The device of claim 11, wherein the spring is disposed such that it exerts a force between the shaft and the support shaft.

13. The device of claim 10, wherein the size of the planar surface of the contact plate is selected based on the type of terrain the contact plate will encounter.

14. The device of claim 10, wherein the one or more attachment portions are configured to receive a fastener.

15. The device of claim 14, wherein the fastener is a screw or bolt.
